(19) United States
(12) Patent Application Publication
(10) Pub. No.: US 2012/0021236 A1
(43) Pub. Date: Jan. 26, 2012

(54) TRANSPARENT, WEATHERING-RESISTANT BARRIER FOIL, PRODUCTION THEREOF BY MEANS OF LAMINATION, EXTRUSION LAMINATION OR EXTRUSION COATING

(75) Inventors: Claudius Neumann, Rossdorf (DE); Florian Schwager, Muenster (DE); Ghirmay Seyoum, Egelsbach (DE); Ekkehard Beer, Bad Schwalbach (DE)

(73) Assignee: EVONIK ROEHM GMBH, DARMSTADT (DE)

(21) Appl. No.: 13/259,155

(22) PCT Filed: Apr. 28, 2010
(86) PCT No.: PCT/EP10/55660

§ 371 Date: Sep. 23, 2011

(30) Foreign Application Priority Data
May 19, 2009 (DE) 10-2009-003-225.8

(51) Int. Cl. B32B 27/00; B32B 33/00; B32B 19/00

(52) U.S. Cl. 428/500; 428/688; 156/151

(57) ABSTRACT

The invention relates to a barrier foil, wherein a barrier composite (5) consisting of two carrier foils (3), each of which contains an inorganic barrier (4) (SiOx or AlOx), is combined by lamination or extrusion coating with a weather-resistant protective layer (1), wherein a bonding agent is used as an adhesive layer (2).

### FIELD OF THE INVENTION

The invention relates to the production of a transparent, weathering-resistant barrier film by lamination, extrusion lamination (adhesive, melt or hotmelt lamination) or extrusion coating. For this purpose, a transparent film composite consisting of two external polyolefin or polyester layers, which are in each case provided with an inorganic coating and bonded to one another with the inorganic layer on the inside, is laminated with a weathering-resistant, transparent film (e.g. PMMA or PMMA-polyolefin coextrudate or PMMA-polyester coextrudate). The inorganic oxide layer has the property of a high, transparent barrier to water vapour and oxygen, while the PMMA layer contributes the weathering stability.

### PRIOR ART

Weathering-resistant, transparent and impact-resistant polymethacrylate-based films are sold by the applicant under the name PLEXIGLAS®. The patent DE 38 42 796 A1 describes the production of a clear, impact-resistant acrylate-based moulding material, films and mouldings produced therefrom and a process for the production of the moulding materials. These films have the advantage that they do not become discoloured and/or brittle under the action of heat and moisture. Furthermore, they avoid the so-called white fracture in the case of impact or bending stress. These films are transparent and remain so even under the action of heat and moisture, on weathering and in the case of impact or bending stress.

The processing of the moulding material to give said transparent, impact-resistant films is ideally effected by extrusion of the melt through a slot die and calendering on a roll mill. Such films are distinguished by permanent transparency, insensitivity to heat and cold, weathering resistance, little yellowing and embrittlement and by little white fracture on flexing or folding and are therefore suitable, for example, as windows in tarpaulins, car tops or sails. Such films have a thickness of less than 1 mm, for example 0.02 mm to 0.5 mm. An important area of use is the formation of thin surface layers of, for example, 0.02 mm to 0.5 mm thickness on stiff, dimensionally stable base bodies, such as metal sheets, boards, chipboards, plastic sheets and the like. Various methods are available for the production of such coverings. Thus, the film can be extruded to give a moulding material, calendered and laminated with the substrate. By means of the extrusion coating technique, an extruded strand can be applied to the surface of the substrate and calendered by means of a roll. If a thermoplastic is used as the substrate itself, coextrusion of the two materials with formation of a surface layer from the clear moulding material of the invention is possible.

However, PMMA films provide only inadequate barrier properties with respect to water vapour and oxygen, which however is necessary for medical applications, applications in the packaging industry, but especially in electrical applications which are used outdoors.

For improving the barrier properties, transparent, inorganic layers are applied to polymer films. In particular, silica and alumina layers have become established. This inorganic oxide layer (SiOₓ or AlOₓ) is applied by the vacuum coating process (chemically, JP-A-10025357, JP-A-07074378; thermal or electron beam vaporization, sputtering, EP 1 018 166 B1, JP 2000-307136 A, WO 2005-029601 A2). EP 1018166 B1 demonstrates that the UV absorption of the SiO_{X} layer can be influenced via the ratio of silicon to oxygen of the SiOₓ layer. This is important for protecting underlying layers from UV radiation. However, the disadvantage is that, with the change in the ratio of silicon to oxygen, the barrier property, too, changes. Thus, transparency and barrier property cannot be varied independently of one another.

The inorganic oxide layer has occasionally been applied mainly to polyesters and polyolefins since these materials withstand the thermal stress during the vaporization process. Moreover, the inorganic oxide layer adheres well to polyesters and polyolefins, the latter being subjected to a corona treatment prior to coating. However, since these materials are not stable to weathering, they are often laminated with halogenated films, as described, for example, in WO 94/29106. Halogenated films are, however, problematic for environmental protection reasons.

As is known from U. Moosheimer, Galvanotechnik 90 No. 9, 1999, p. 2526-2531, the coating of PMMA with an inorganic oxide layer does not improve the barrier property with respect to water vapour and oxygen since PMMA is amorphous. However, in contrast to polyesters and polyolefins, PMMA is stable to weathering.

In DE 102009000450.5, the applicant uses coats which result in good adhesion between the inorganic layer and the adhesion promoter. As is known to the person skilled in the art, the adhesion between organic and inorganic layers is more difficult to achieve than between layers of the same type.

### OBJECT

It was the object of the invention to provide a barrier film which is stable to weathering and highly transparent (>80% in the wavelength range>300 nm), good barrier properties with respect to water vapour and oxygen being ensured. PMMA fulfils the property of weathering stability, the inorganic oxide layer fulfils the barrier properties.

The present invention has firstly the object of combining PMMA as a substrate layer with inorganic oxide layers.

Secondly, the function of protection from UV radiation is to be performed no longer by the inorganic oxide layer, so that this can be optimized exclusively according to optical criteria, but by the PMMA layer. Thirdly, a partial discharge voltage of greater than 1000 V is to be achieved by this material combination.

Fourthly, the PMMA layer has the function of protecting the underlying polyolefin or polyester layers from weathering influences.

### SOLUTION

The object is achieved by a barrier film which is stable to weathering. The properties are achieved by a multilayer film, the individual layers being combined with one another by vacuum vapour deposition, lamination, extrusion lamination (adhesive, melt or hotmelt lamination) or extrusion coating. Customary processes, as described, for example, in S.E.M. Selke, J. D. Culter, R. J. Hernandez, “Plastics Packaging”, 2^{nd} Edition, Hanser-Verlag, ISBN 1-56990-372-7, on pages 226 and 227, can be used for this purpose.

Since the direct inorganic coating of PMMA is not possible according to the prior art, a polyester or polyolefin film is provided with the inorganic layer by vapour deposition. The PMMA layer protects the polyester or polyolefin film from weathering influences.

The problem of adhesion between inorganic and organic layers is circumvented by adhesively bonding to one another two films having an inorganic coating with the inorganic side facing inwards, the organic film side pointing outwards. This can then easily be bonded to other organic polymers.

Adhesion between the inorganic layers can be achieved, for example, with a polyurethane-based adhesive which is optimized for inorganic layers.

The film composite, which contains the two inorganic layers, can be bonded to one another by means of a hotmelt adhesive with PMMA, imPMMA or a film composite comprising PMMA or imPMMA and polyolefin or polyester by extrusion lamination.

The PMMA layer also contains a UV absorber which protects the polyester or polyolefin film from UV radiation. The UV absorber can, however, also be present in the polyolefin or polyester layer. Instead of the PMMA layer, it is also possible to use a coextrudate of PMMA and polyolefin, which has cost benefits since polyolefins are more economical than PMMA.

### ADVANTAGES OF THE INVENTION

The barrier film according to the invention is stable to weathering.

The barrier film according to the invention is halogen-free.

The barrier film according to the invention has a good barrier effect with respect to water vapour and oxygen (<0.05 g/(m²d)).

The barrier film according to the invention protects underlying layers from UV radiation independently of the composition of the SiOₓ layer.

The barrier film according to the invention can be economically produced since a thin film can be used for the discontinuous process of inorganic vacuum vapour deposition.

The barrier film according to the invention can be easily produced since only inorganic layers need be bonded to inorganic layers and organic layers to organic layers.

The Protective Layer

Films comprising preferably polymethyl methacrylate (PMMA) or impact-resistant PMMA (ir-PMMA) are used as the protective layer.

Impact-Modified Poly(Meth)Acrylate Plastic

The impact-modified poly(meth)acrylate plastic consists of 20% by weight to 80% by weight, preferably 30% by weight to 70% by weight, of a poly(meth)acrylate matrix and 80% by weight to 20% by weight, preferably 70% by weight to 30% by weight of elastomer particles having a mean particle diameter of 10 nm to 150 nm (measuring, for example, using the ultracentrifuge method).

Preferably, the elastomer particles distributed in the poly(meth)acrylate matrix have a core comprising a soft elastomer phase and a hard phase bound thereto.

The impact-modified poly(meth)acrylate plastic (imPMMA) consists of a proportion of matrix polymer, obtained by polymerization of at least 80% by weight of units of methyl methacrylate and optionally 0% by weight to 20% by weight of units of monomers copolymerizable with methyl methacrylate, and a proportion, distributed in the matrix, of impact modifiers based on crosslinked poly(meth)acrylates.

The matrix polymer consists in particular of 80% by weight to 100% by weight, preferably 90% by weight-99.5% by weight, of methyl methacrylate units subjected to free radical polymerization and optionally 0% by weight-20% by weight, preferably 0.5% by weight-10% by weight, of further comonomers capable of free radical polymerization, e.g. C₁- to C₄-alkyl (meth)acrylates, in particular methyl acrylate, ethyl acrylate or butyl acrylate. Preferably, the average molecular weight M_{w} (weight average) of the matrix is in the range from 90 000 g/mol to 200 000 g/mol, in particular 100 000 g/mol to 150 000 g/mol (determination or M_{w} by means of gel permeation chromatography with reference to polymethyl methacrylate as a calibration standard). The determination of the molecular weight M_{w} can be effected, for example, by gel permeation chromatography or by the scattered light method (cf. for example B.H.F. Mark et al., Encyclopaedia of Polymer Science and Engineering, 2nd Edition, Vol. 10, page 1 et seq., J. Wiley, 1989).

A copolymer of 90% by weight to 99.5% by weight of methyl methacrylate and 0.5% by weight to 10% by weight of methyl acrylate is preferred. The Vicat softening temperatures VST (ISO 306-B50) may be in the range of at least 90, preferably from 95 to 112, ° C.

The Impact Modifier

The polymethacrylate matrix contains an impact modifier which may be, for example, an impact modifier composed of two or three shells.

The impact modifiers for polymethacrylate plastics are sufficiently well known. Preparation and composition of impact-modified polymethacrylate moulding materials are described, for example, in EP-A 0 113 924, EP-A 0 522 351, EP-A 0 465 049 and EP-A 0 683 028.

Impact Modifier

The polymethacrylate matrix contains 1% by weight to 30% by weight, preferably 2% by weight to 20% by weight, particularly preferably 3% by weight to 15% by weight, in particular 5% by weight to 12% by weight, of an impact modifier which is in the elastomer phase comprising crosslinked polymer particles. The impact modifier is obtained in a manner known per se by bead polymerization or by emulsion polymerization.

In the simplest case, said particles are crosslinked particles obtainable by means of bead polymerization and having a mean particle size in the range from 10 nm to 150 nm, preferably 20 nm to 100 nm, in particular 30 nm to 90 nm. These consist as a rule of at least 40% by weight, preferably 50% by weight-70% by weight, of methyl methacrylate, 20% by weight to 40% by weight, preferably 25% by weight to 35% by weight, of butyl acrylate and 0.1% by weight to 2% by weight, preferably 0.5% by weight to 1% by weight, of a crosslinking monomer, for example a polyfunctional (meth)acrylate, such as, for example, allyl methacrylate, and optionally further monomers, such as, for example, 0% by weight to 10% by weight, preferably 0.5% by weight to 5% by weight, of C₁-C₄-alkyl methacrylates, such as ethyl acrylate or butyl methacrylate, preferably methyl acrylate, or other vinylically polymerizable monomers, such as, for example, styrene.

Preferred impact modifiers are polymer particles which may have a two- or three-layer core-shell structure and are obtained by emulsion polymerization (cf. for example EP-A 0 113 924, EP-A 0 522 351, EP-A 0 465 049 and EP-A 0 683 028). Suitable particle sizes of these emulsion polymers must, however, be in the range of 10 nm-150 nm, preferably 20 nm to 120 nm, particularly preferably 50 nm to 100 nm, for the purposes of the invention.

A three-layer or three-phase structure comprising a core and two shells can have the following characteristics. An inner (hard) shell may comprise, for example, substantially methyl methacrylate, small proportions of comonomers, such as, for example, ethyl acrylate, and a crosslinker fraction, e.g. allyl methacrylate. The middle (soft) shell may be composed, for example, of butyl acrylate and optionally styrene, while the outermost (hard) shell generally substantially corresponds to the matrix polymer, with the result that the compatibility and good binding to the matrix are brought about. The proportion of polybutyl acrylate in the impact modifier is decisive for the toughening effect and is preferably in the range from 20% by weight to 40% by weight, particularly preferably in the range from 25% by weight to 35% by weight.

Impact-Modified Polymethacrylate Moulding Materials

In the extruder, the impact modifier and matrix polymer can be mixed in the melt to give impact-modified polymethacrylate moulding materials. The material discharged is as a rule first pelletized. This can be further processed by means of extrusion or injection moulding to give mouldings, such as sheets or injection-moulded parts.

Two-Phase Impact Modifier According to EP 0 528 196 A1

A system known in principle from EP 0 528 196 A1 is preferably used, in particular for film production, but is not limited to this, said system being a two-phase, impact-modified polymer comprising:

a1) 10% by weight to 95% by weight of a cohesive hard phase having a glass transition temperature T_{mg} above 70° C., composed of

a11) 80% by weight to 100% by weight (based on al) of methyl methacrylate and

a12) 0% by weight to 20% by weight of one or more further ethylenically unsaturated monomers capable of free radical polymerization, and

a2) 90% by weight to 5% by weight of a tough phase distributed in the hard phase and having a glass transition temperature T_{mg} below −10° C., composed of

a21) 50% by weight to 99.5% by weight of a C₁-C₁₀-alkyl acrylate (based on a2),

a22) 0.5% by weight to 5% by weight of a crosslinking monomer have two or more ethylenically unsaturated radicals capable of free radical polymerization, and

a23) optionally further ethylenically unsaturated monomers capable of free radical polymerization, at least 15% by weight of the hard phase a1) being covalently linked to the tough phase a2).

The two-phase impact modifier can be produced by two-stage emulsion polymerization in water, as described, for example, in DE-A 38 42 796. In the first stage, the tough phase a2) is produced, which is composed of at least 50% by weight, preferably more than 80% by weight, of lower alkyl acrylates, resulting in a glass transition temperature T_{mg} of this phase of less than −10° C. Crosslinking monomers a22) used are (meth)acrylates of diols, such as, for example, ethylene glycol dimethacrylate or 1,4-butanediol dimethacrylate, aromatic compounds having two vinyl or allyl groups, such as, for example, divinylbenzene, or other crosslinking agents having two ethylenically unsaturated radicals capable of free radical polymerization, such as, for example, allyl methacrylate as a graft-linker.

Triallyl cyanurate, trimethylolpropane triacrylate and trimethacrylate and pentaerythrityl tetraacrylate and tetramethacrylate may be mentioned by way of example as crosslinking agents having three or more unsaturated groups capable of free radical polymerization, such as allyl groups or (meth)acryloyl groups. Further examples in this context are mentioned in U.S. Pat. No. 4,513,118.

The ethylenically unsaturated monomers capable of free radical polymerization and mentioned under a23) may be, for example, acrylic or methacrylic acid and their alkyl esters having 1-20 carbon atoms, unless already mentioned, it being possible for the alkyl radical to be straight-chain, branched or cyclic. Furthermore, a23) may comprise further aliphatic comonomers which are capable of free radical polymerization and are copolymerizable with the alkyl acrylates a21). However, significant proportions of aromatic comonomers, such as styrene, alpha-methylstyrene or vinyltoluene, should remain excluded since—especially on weathering—they lead to undesired properties of the moulding material A.

In the production of the tough phase in the first stage, careful attention must be paid to establishing the particle size and the nonuniformity thereof. The particle size of the tough phase depends substantially on the concentration of the emulsifier. Advantageously, the particle size can be controlled by the use of a seed latex. Particles having an average particle size (weight average) below 130 nm, preferably below 70 nm, and having a nonuniformity U₈₀ of the particle size below 0.5 (U₈₀ is determined from an integral consideration of the particle size distribution which is determined by means of ultracentrifuge. The following is true: U₈₀=[(r₉₀−r₁₀)/r₅₀]−1, where r₁₀, r₅₀, r₉₀=average integral particle radius for which 10, 50, 90% of the particle radii are below and 90, 50, 10% of the particle radii are above this value), preferably below 0.2, are achieved with emulsifier concentrations of 0.15 to 1.0% by weight, based on the water phase. This is true in particular for anionic emulsifiers, such as, for example, the particularly preferred alkoxylated and sulphated paraffins. Polymerization initiators used are, for example, 0.01 to 0.5% by weight of alkali metal or ammoniumperoxodisulphate, based on the water phase, and the polymerization is initiated at temperatures of 20 to 100° C. Redox systems, for example a combination of 0.01% by weight to 0.05% by weight of organic hydroperoxide and 0.05% by weight to 0.15% by weight of sodium hydroxymethylsulphinate, are preferably used, at temperatures of 20 to 80° C.

The hard phase a1) covalently bonded in an amount of at least 15% by weight to the tough phase a2) has a glass transition temperature of at least 70° C. and may be composed exclusively of methyl methacrylate. Up to 20% by weight of one or more further ethylenically unsaturated monomers capable of free radical polymerization may be present as comonomers a12) in the hard phase, alkyl (meth)acrylates, preferably alkyl acrylates having 1 to 4 carbon atoms, being used in amounts such that the glass transition temperature does not fall below the abovementioned glass transition temperature.

The polymerization of the hard phase a1) takes place in a second stage, likewise in emulsion, with the use of the customary auxiliaries, as are already used, for example, for the polymerization of the tough phase a2).

In a preferred embodiment, the hard phase contains low molecular weight UV absorbers and/or UV absorbers incorporated in the form of polymerized units, in amounts of 0.1% by weight to 10% by weight, preferably 0.5% by weight-5% by weight, based on A as a constituent of the comonomer components a12) in the hard phase. 2-(2′-Hydroxyphenyl)-5-methacrylamidobenzotriazole or 2-hydroxy-4-methacryloyloxybenzophenone may be mentioned by way of example for the polymerizable UV absorbers as are described, inter alia, in U.S. Pat. No. 4 576 870. Low molecular weight UV absorbers may be, for example, derivatives of 2-hydroxybenzophenone or of 2-hydroxyphenylbenzotriazole or phenyl salicylate. In general, the low molecular weight UV absorbers have a molecular weight of less than 2×10³ (g/mol). UV absorbers having low volatility at the processing temperature and homogeneous miscibility with the hard phase a1) of the polymer A are particularly preferred.

Coextrudates of polymethacrylates and polyolefins or polyesters can also be used. Coextrudates of polypropylene and PMMA are preferred. Furthermore, a fluorinated, halogenated layer is also possible, such as, for example, a coextrudate of PVDF with PMMA or a blend of PVDF and PMMA, but the advantage of freedom from halogen would be absent.

The protective layer has a thickness of 20 μm to 500 μm; the thickness is preferably 50 μm to 400 μm and very particularly preferably 200 μm to 300 μm.

Light Stabilizers

According to the invention, light stabilizers can be added to the substrate layer. Light stabilizers are to be understood as meaning UV absorbers, UV stabilizers and free radical scavengers.

Optionally present UV stabilizers are, for example, derivatives of benzophenone, the substituents of which, such as hydroxyl and/or alkoxy groups, are generally present in the 2- and/or 4-position. These include 2-hydroxy-4-n-octyloxybenzophenone, 2,4-dihydroxybenzophenone, 2,2′-dihydroxy-4-methoxybenzophenone, 2,2′,4′,4′-tetrahydroxybenzophenone, 2,2′-dihydroxy-4,4′-dimethoxybenzophenone, 2-hydroxy-4-methoxy-benzophenone. Furthermore, substituted benzotriazoles are very suitable as an added UV stabilizer, including in particular 2-(2-hydroxy-5-methylphenyl)benzo-triazole, 2-[2-hydroxy-3,5-di(alpha,alpha-dimethyl-benzyl)phenyl]benzotriazole, 2-(2-hydroxy-3,5-di-tert-butylphenyl)benzotriazole, 2-(2-hydroxy-3,5-dibutyl-5-methylphenyl)-5-chlorobenzotriazole, 2-(2-hydroxy-3,5-di-tert-butylphenyl)-5-chlorobenzotriazole, 2-(2-hydroxy-3,5-di-tert-amylphenyl)benzotriazole, 2-(2-hydroxy-5-tert-butylphenyl)benzotriazole, 2-(2-hydroxy-3-sec-butyl-5-tert-butylphenyl)benzotriazole and 2-(2-hydroxy-5-tert-octylphenyl)benzotriazole, phenol, 2,2′-methylenebis[6-(2H-benzotriazol-2-yl)-4-(1,1,3,3-tetra-methylbutyl)].

In addition to the benzotriazoles, a UV absorber from the class consisting of the 2-(2′-hydroxyphenyl)-1,3,5-triazines, such as, for example, phenol, 2-(4,6-di-phenyl-1,2,5-triazin-2-yl)-5-(hexyloxy), can also be used.

UV stabilizers which may furthermore be used are ethyl 2-cyano-3,3-diphenylacrylate, 2-ethoxy-2′-ethyl-oxanilide, 2-ethoxy-5-tert-butyl-2′-ethyloxanilide and substituted phenyl benzoates.

The light stabilizers or UV stabilizers can be present as low molecular weight compounds, as stated above, in the polymethacrylate materials to be stabilized. However, UV-absorbing groups may also be covalently bonded in the matrix polymer molecules after copolymerization with polymerizable UV absorption compounds, such as, for example, acrylate, methacrylate or allyl derivatives of benzophenone or benzotriazole derivatives.

The proportion of UV stabilizers, it also being possible for these to be mixtures of chemically different UV stabilizers, is as a rule 0.01% by weight to 10% by weight, especially 0.01% by weight to 5% by weight, in particular 0.02% by weight to 2% by weight, based on the (meth)acrylate copolymer.

Sterically hindered amines, which are known by the name HALS (hindered amine light stabilizer) may be mentioned here as an example of free radical scavengers/UV stabilizers. They can be used for inhibiting ageing processes in finishes and plastics, especially in polyolefin plastics (Kunststoffe, 74 (1984) 10, pages 620 to 623; Farbe +Lack, 96^{th} year, 9/1990, pages 689 to 693). The tetramethylpiperidine group present in the HALS compounds is responsible for the stabilizing effect of said compounds. This class of compounds may be either unsubstituted or substituted by alkyl or acyl groups on the piperidine nitrogen. The sterically hindered amines do not absorb in the UV range. They trap free radicals which have formed, which the UV absorbers in turn cannot do.

Examples of HALS compounds which have a stabilizing effect and can also be used as mixtures are: bis(2,2,6,6-tetramethyl-4-piperidyl) sebacate, 8-acetyl-3-dodecyl-7,7,9,9-tetramethyl-1,3,8-triaza-spiro(4,5)decane-2,5-dione, bis(2,2,6,6-tetramethyl-4-piperidyl) succinate, poly(N-(β-hydroxyethyl-2,2,6,6-tetramethyl-4-hydroxypiperidine succinic acid ester) or bis(N-methyl-2,2,6,6-tetramethyl-4-piperidyl) sebacate.

Particularly preferred UV absorbers are, for example, Tinuviri 234, Tinuvin 360, Chimasorb® 119 or Irganox® 1076.

The free radical scavengers/UV stabilizers are used in the polymer mixtures according to the invention in amounts of 0.01% by weight to 15% by weight, especially in amounts of 0.02% by weight to 10% by weight, in particular in amounts of 0.02% by weight to 5% by weight, based on the (meth)acrylate copolymer.

The UV absorber is preferably present in the PMMA layer but may also be present in the polyolefin or polyester layer.

The protective layer also has a sufficient layer thickness to ensure the partial discharge voltage of 1000 V. For example, in the case of PMMA, this is from 250 μm depending on the thickness. The partial discharge voltage is understood as meaning the voltage at which an electrical discharge takes place which partly bridges the insulation (cf. DIN EN 60664-1).

The Substrate Layer

Films preferably comprising polyolefins (PE, PP) or polyesters (PET, PET-G, PEN) are used as substrate layer. Films comprising other polymers can also be used (for example polyamides or polylactic acid). The substrate layer has a thickness of 1 μm to 100 μm; the thickness is preferably 5 μm to 50 μm and very particularly preferably 10 μm to 30 μm.

The substrate layer has a transparency of more than 80%, preferably more than 85%, particularly preferably more than 90%, in the wavelength range of >300 nm, preferably 350 to 2000 nm, particularly preferably 380 to 800 nm.

The Barrier Layer

The barrier layer is applied to the substrate layer and preferably consists of inorganic oxides, for example SiOₓ or AlOₓ. However, it is also possible to use other inorganic materials (for example SiN, SiNₓO_{y}, ZrO, TiO₂, ZnO, FeₓO_{y} transparent organometallic compounds). For the exact layer structure, see working examples. SiOₓ layers used are preferably layers having the ratio of silicon to oxygen of 1:1 to 1:2, particularly preferably 1:1.3 to 1:1.7. The layer thickness is 5 nm-300 nm, preferably 10 nm-100 nm, particularly preferably 20 nm-80 nm.

For x in the case of AlOx, a range of 0.5 to 1.5; preferably of 1 to 1.5 and very particularly preferably of 1.2 to 1.5 is applicable (x being 1.5 Al₂O₃). The layer thickness is 5 nm-300 nm, preferably 10 nm-100 nm, particularly preferably 20 nm-80 nm.

The inorganic oxides may be applied by means of physical vacuum deposition (electron beam or thermal process), magnetron sputtering or chemical vacuum deposition. This can be done reactively (with supply of oxygen) or non-reactively. Flame, plasma or corona pretreatment is also possible.

The Barrier Composite—Consisting of 2 Substrate Layers Having an Inorganic Coating

The composite comprising 2 substrate layers having an inorganic coating (=provided with barrier layer) has the advantage that the two inorganic layers are protected by the two outer substrate layers. On lamination with the protective film, the barrier layer is therefore not damaged. Furthermore, the adhesive which is used for producing the composite can be optimized for the inorganic layer. The formulations described in the section “The adhesive layer” can be used as adhesives. A two-component polyurethane-based adhesive is preferred here.

The Adhesive Layer

The adhesive layer is present between protective layer and barrier layer. It permits the adhesion between the two layers. The adhesive layer has a thickness of 1 μm-100 μm, preferably 2 μm-50 μm, particularly preferably 2 μm-20 μm. The adhesive layer can be formed from a coating formulation which is subsequently cured. This is preferably effected by UV radiation but can also take place thermally. The adhesive layer contains 1% by weight-80% by weight of polyfunctional methacrylates or acrylates or mixtures thereof as the main component. Polyfunctional acrylates, e.g. hexanediol dimethacrylate, are preferably used. For increasing the flexibility, it is possible to add monofunctional acrylates or methacrylates, for example hydroxyethyl methacrylate or lauryl methacrylate. Furthermore, the adhesive layer optionally contains a component which improves the adhesion to SiOₓ, for example acrylates or methacrylates containing siloxane groups, e.g. methacryloyloxypropyltrimethoxysilane. The acrylates or methacrylates containing siloxane groups may be present in an amount of 0% by weight-48% by weight in the adhesive layer. The adhesive layer contains 0.1% by weight-10% by weight, preferably 0.5% by weight-5% by weight, particularly preferably 1% by weight-3%, of initiator, e.g. Irgacure® 184 or Irgacure® 651. The adhesive layer may also contain 0% by weight-10% by weight, preferably 0.1% by weight -10% by weight, particularly preferably 0.5% by weight-5%, of sulphur compounds as chain-transfer agents. One variant is to replace a part of the main component by 0% by weight-30% by weight of prepolymer. The adhesive component optionally contains 0% by weight-40% by weight of the additives customary for adhesives. The adhesive layer can, however, also be formed from a hotmelt adhesive. This may consist of polyamides, polyolefins, thermoplastic elastomers (polyester, polyurethane or copolyamide elastomers) or of copolymers. Ethylene-vinyl acetate copolymers or ethylene-acrylate copolymers or ethylene-methacrylate copolymers are preferred. The adhesive layer can be applied by means of roll coating methods in lamination or by means of a nozzle in extrusion lamination or in extrusion coating.

A prepolymer is understood as meaning a monomer-polymer mixture which forms as a result of only partial polymerization of the monomer (see for example DE10349544A1).

Use

This barrier film can be used in the packaging industry, display technology, organic photovoltaics, in thin-film photovoltaics, in crystalline silicon modules and for organic LEDs.

Working Examples

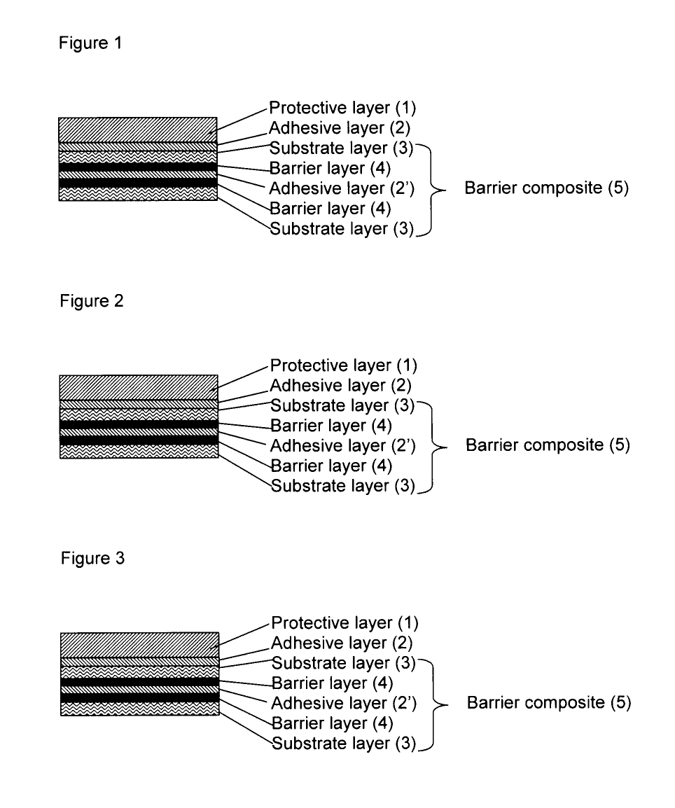

FIG. 1 shows a working example with protective layer—adhesive layer—barrier composite, lamination

A substrate layer (3) (e.g. PET) is coated with a barrier layer (4) (e.g. SiOₓ). This is bonded to a second SiOₓ-coated substrate layer by roll coating methods by means of an adhesive layer (2′). The protective layer (1) (e.g. PMMA) is applied on this barrier composite by lamination. For example, an acrylate- or methacrylate-based adhesion promoter can be used as adhesive layer (2) for the lamination. This can be applied by a roll- or kiss-coating method. The protective layer (1) is distinguished in that it contains a UV absorber.

Process:

1. Vacuum coating (PVD, CVD) of the substrate layer (4)

2. Production of the barrier composite by bonding two coated substrate layers by means of roll coating methods, whereby an adhesive layer (2′) is produced

3. Application of the protective layer (1) to the barrier composite (5) by means of lamination (roll coating method) with the use of an adhesion promoter which represents the adhesive layer (2)

4. Curing of the adhesive layer (2) by UV radiation

FIG. 2 shows a working example with protective layer—barrier composite, extrusion coating

A substrate layer (3) (e.g. PET) is coated with a barrier layer (4) (e.g. SiOₓ). This is bonded to a second SiOₓ-coated substrate layer by roll coating methods by means of an adhesive layer (2′). The protective layer (1) in the molten state (e.g. PMMA-PP coextrudate) is applied on this barrier composite by extrusion coating. Optionally, the adhesion of the protective layer on the barrier layer can be improved by an adhesive layer (2), e.g. acrylate- or methacrylate-based adhesion promoter, or hotmelt adhesive, for example based on ethylene-acrylate copolymer.

The protective layer (1) is distinguished in that it contains a UV absorber and in that it consists of two or three layers (PMMA and PP or PMMA, adhesion promoter or hotmelt adhesive and PP).

Process:

1. Vacuum coating (PVD, CVD) of the substrate layer (4)

2. Production of the barrier composite by bonding two coated substrate layers by means of roll coating methods, whereby an adhesive layer (2′) is produced

3. Application of the protective layer (1) to the barrier composite (5) by means of multilayer extrusion coating possibly with the use of a hotmelt adhesive, which represents the adhesive layer (2)

FIG. 3 shows a working example with protective layer—barrier composite—substrate layer, extrusion lamination

A substrate layer (3) (e.g. PET) is coated with a barrier layer (4) (e.g. SiOₓ). This is bonded to a second SiOₓ-coated substrate layer by roll coating methods by means of an adhesive layer (2′). The protective layer (1) (e.g. PMMA film or coextrudates of PMMA and polyolefins) is applied on this barrier composite (5) by extrusion lamination. For example, a hotmelt adhesive, for example based on ethylene-acrylate copolymer, can be used as adhesive layer (2) for the lamination. This hotmelt adhesive is extruded by means of a die in the molten state between the barrier composite (5) and the protective layer (1). The protective layer (1) is distinguished in that it contains a UV absorber.

Process:

1. Vacuum coating (PVD, CVD) of the substrate layer (4)

2. Production of the barrier composite by bonding two coated substrate layers by means of roll coating methods, whereby an adhesive layer (2′) is produced

3. Extrusion lamination of the adhesive layer (2) in the molten state between the protective layer (1) and the barrier composite

Measurement of the Barrier Property of the Film According to the Invention

The measurement of the water vapour permeability of the film system is effected according to ASTM F-1249 at 23° C./85% relative humidity.

The measurement of the partial discharge voltage is effected according to DIN 61730-1 and IEC 60664-1 or DIN EN 60664-1.

### EXAMPLES

### Comparative Example

A film according to the prior art (EP 1 018 166 B1), e.g. SiOₓ-coated ETFE having a layer thickness of 50 μm, has a water vapour permeability of 0.7 g/(m²d).

A film according to the invention having a layer thickness of the barrier composite (5) of 50 μm has a water vapour permeation rate between 0.01 and 0.05 g/(m²d) (cf. Example 1).

### Example 1

Protective layer (1): PMMA, layer thickness 50 μm, contains 1% of UV absorber Tinuvin® 234.

Adhesive layer (2): 62% of Laromer UA 9048 V, 31% of hexanediol dimethacrylate, 2% of hydroxyethyl methacrylate, 3% of Irgacure 651, 2% of 3-methacryloyloxypropyltrimethoxysilane

Barrier composite (5) consisting of:

Substrate layer (3): PET Mitsubishi Hostaphan RN12, layer thickness: 12 μm.

Barrier layer (4): SiO_{1.5} applied by means of electron beam vacuum vaporization,

Layer thickness: 40 nm.

Adhesive layer (2′): two-component system Liofol LA 2692-21 and curing agent UR 7395-22 from Henkel

### Example 2

Protective layer (1): impact-resistant PMMA, layer thickness: 250 μm, contains 2% of UV absorber Cesa Light® GXUVA006.

Adhesive layer (2): 62% of Laromer UA 9048 V, 31% of hexanediol diacrylate, 2% of hydroxyethyl methacrylate, 3% of Irgacure 184, 2% of butyl acrylate

Barrier composite (5) consisting of:

Substrate layer (3): PEN, layer thickness: 20 μm

Barrier layer (4): Al₂O₃, layer thickness 40 nm, applied by means of magnetron sputtering.

Adhesive layer (2′): 60% of Laromer UA 9048 V, 30% of hexanediol diacrylate, 2% of hydroxyethyl methacrylate, 3% of Irgacure 184, 2% of butyl acrylate, 4% of methacryloyloxypropyltrimethoxysilane

### Example 3

Protective layer (1): coextrudate of PMMA and impact-resistant PMMA, layer thickness 150 μm, contains 1.5% of UV absorber Tinuvin® 360.

Adhesive layer (2): 62% of Ebecryl 244, 31% of hexanediol diacrylate, 2% of hydroxyethyl methacrylate, 3% of Irgacure 651, 2% of glymo

Barrier composite (5) consisting of:

Substrate layer (3): PET, layer thickness 23 μm.

Barrier layer (4): SiO_{1.7}, layer thickness 80 nm, applied by means of magnetron sputtering.

Adhesive layer (2′): 70% of hexanediol diacrylate, 17% of pentaerythrityl tetraacrylate, 5% of methyl methacrylate, 2% of Irgacure 184, 2% of hydroxyethyl methacrylate, 2% of methacryloyloxypropyltrimethoxysilane

### Example 4

Protective layer (1): coextrudate of impact-resistant PMMA (e.g. Plex 8943F), layer thickness 40 μm, contains 1.5% of UV absorber Tinuvin® 360 and polyethylene (e.g. Dowlex SC 2108 G), layer thickness 200 μm. Adhesion promoter: Dupont Bynel 22 E 780 (ethylene-acrylate copolymer).

Adhesive layer (2): Dupont Bynel 22 E 780

Barrier composite (5) consisting of:

Substrate layer (3): PET Mitsubishi Hostaphan RN75, layer thickness 75 μm

Barrier layer (4): SiO_{1.7}, layer thickness 80 nm, applied by means of electron beam vacuum vaporization.

Adhesive layer (2′): two-component system Liofol LA 2692-21 and curing agent UR 7395-22 from Henkel

The % data in the examples are always % by weight.

### LIST OF REFERENCE NUMERALS

1 Protective layer

2 Adhesive layer

2′ Adhesive layer of the barrier composite (5)

3 Substrate layer

4 Barrier layer

5 Barrier composite

1. Barrier film consisting of a weathering-stable protective layer and a barrier composite, the protective layer being stable to weathering and the barrier composite containing two inorganic oxide layers which improve the barrier effect with respect to water vapour and oxygen.

2. Barrier film according to claim 1, characterized in that it is halogen-free.

3. Barrier film according to claim 1, characterized in that it has a partial discharge voltage of at least 1000 V.

4. Barrier film according to claim 1, characterized in that it has a transparency of more than 80% in the range of more than 300 nm.

5. Barrier film according to claim 1, characterized in that an adhesive layer which is formed from an adhesion promoter having the following composition:
a) 1% by weight - 80% by weight of mono- or polyfunctional acrylates or methacrylates
b) 0% by weight-30% by weight of a prepolymer
c) 0% by weight-48% by weight of an acrylate or methacrylate containing siloxane groups
d) 0.1% by weight-10% by weight of at least one initiator
e) 0% by weight-10% by weight of at least one chain-transfer agent
f) 0% by weight-40% by weight of customary additives
is present between the barrier composite and the protective layer.

6. Barrier film according to claim 1, characterized in that an adhesive layer which is formed from a hotmelt adhesive is present between the inorganic barrier layer and the protective layer.

7. Process for the production of the barrier film, characterized in that
a) a substrate film (polyolefin, polyester) is provided with an inorganic coating by means of vacuum vaporization or sputtering and this film is bonded by means of an adhesive layer to a further film having an inorganic coating and the film composite produced in this manner is combined with a weathering-stable plastics film (PMMA, coextrudate of PMMA and polyolefin) by means of lamination, or
b) a substrate film (polyolefin, polyester) is provided with an inorganic coating by means of vacuum vaporization or sputtering and this film is bonded by means of an adhesive layer to a further film having an inorganic coating and the film composite produced in this manner is combined with a weathering-stable plastics film (PMMA, coextrudate of PMMA and polyolefin) by means of extrusion lamination, or
c) a substrate film (polyolefin, polyester) is provided with an inorganic coating by means of vacuum vaporization or sputtering and this film is bonded by means of an adhesive layer to a further film having an inorganic coating and the film composite produced in this manner is combined with a weathering-stable plastics film (PMMA, coextrudate of PMMA and polyolefin) by means of extrusion coating, and
d) SiO is vaporized by means of an electron beam in the physical vacuum vaporization mentioned in 7a) to c), or
e) SiO is vaporized thermally in the physical vacuum vaporization mentioned in 7a) to c).

8. Use of barrier films according to claim 1 in the packaging industry, display technology and for organic LEDs.

9. Use of barrier films according to claim 1 in organic photovoltaics, in thin-film photovoltaics and in crystalline silicon modules.
